(19) United States
(12) Patent Application Publication
(10) Pub. No.: US 2015/0086276 A1
(43) Pub. Date: Mar. 26, 2015

(54) CLADDING

(71) Applicant: Trelleborg Offshore U.K. Limited, Skelmersdale (GB)

(72) Inventors: Austin Harbison, Lancashire (GB); Joshua T. Chadwick, Lancashire (GB)

(73) Assignee: Trelleborg Offshore U.K. Limited, Skelmersdale (GB)

(21) Appl. No.: 14/387,013

(22) PCT Filed: Mar. 22, 2013
(86) PCT No.: PCT/GB2013/050749

§ 371 Date: Sep. 22, 2014

(30) Foreign Application Priority Data
Mar. 22, 2012 (GB) 1205059.7

(51) Int. Cl. E21B 17/01; F15D 1/10; B29C 51/26

(52) U.S. Cl. CPC E21B 17/01; B29C 51/266; F15D 1/10; B29L 2023/22
USPC 405/216; 264/261

(57) ABSTRACT

A cladding section (100, 200) for mounting upon an elongate member to be deployed underwater is shaped to suppress vortex induced vibration of the elongate member when it is subject to a fluid flow, the cladding section comprising at least one cylindrical or part-cylindrical portion (130, 130′, 130″, 230) to seat upon the elongate member and at least one strake (114,114′, 114″, 214) upstanding from the part-cylindrical portion, the cladding section being characterised in that the strake is resilient, enabling it to be deformed when subject to load and to reform following removal of the load. The cladding section may be prepared by methods involving thermoforming or moulding.

The present invention relates to a cladding for suppressing vortex induced vibration of underwater pipes, cables or other elongate members.

When water flows past an underwater pipe, cable or other elongate member, vortices may be shed alternately from either side. The effect of such vortices is to apply fluctuating transverse forces to the member. Such forces can cause the member to bend more than is desirable and impose unwanted additional forces on the member's point of suspension. If the shedding frequency of the vortices is close to a natural frequency of the member then resonance effects can result in particularly severe and potentially damaging oscillation. The problem is experienced particularly in connection with, marine risers of the type used in sub-sea oil drilling and extraction. It is referred to as “vortex induced vibration” or “VIV”

It is known to apply to elongate underwater members a cladding whose exterior is shaped to suppress VIV. Reference is directed in this regard to UK patent application No. 9905276.3 (publication no. 2335248) which discloses an underwater cladding made up of a number of separately formed sections assembled to form a tubular structure receiving an underwater member and having sharp edged helical strakes along its length, which, by controlling transition from laminar to turbulent in a flow of water over the structure, serve to suppress VIV. The sections are moulded from polyurethane and are semi-tubular, a facing pair of such sections being assembled around the underwater member to surround it.

The cladding bas proved itself in practice to be highly effective. However there are commercial pressures to produce a unit which is more economical in manufacture. Additionally the cladding in question has moderately thick walls which add to its mass and also to the area it presents to a flow, so that drag is increased. Reducing the mass and frontal area is desirable.

International patent application PCT/GB2004/0G3709 discloses VIV suppression cladding formed using thermoformed plastics sheet. The sheet material can be relatively thin so that the cladding adds little to the area presented to water flow past the member. Manufacture by thermoforming is economical. The cladding can be thermoformed in a “quasi-flat” state in which multiple part-cylindrical sections lie side-by-side and generally in a common plane. Regions of the sheet material between the part-cylindrical sections form integral hinges enable the cladding to be folded around the elongate member, forming a cylindrical tubular structure. Each part-cylindrical section carries an upstanding VIV suppression strake. The quasi-flat cladding sections can be stacked one upon another making a very compact configuration for transport and storage.

While successful the product disclosed in PCT/GB2004/003709 has certain limitations.

Problems arise with the form of integral hinge disclosed in the prior art document. If formed of substantial material, the cladding sections can become difficult to handle and to bend around the elongate member. Also stiffness of the hinges may cause unwanted deformation of the cladding section when it is installed. End portions of each cladding section are held against the member by taut straps, but between the straps the inherent stiffness of the hinge portions of the thermoformed sheet can result in the cladding adopting a barrel shape, larger in diameter at its midpoint than at its ends. This is undesirable, not least because it increases the area presented to a water flow.

The strakes are potentially vulnerable to damage. Deployment of the elongate member may for example involve it being fed out through a stinger or over a roller, and at that time the cladding can be subject to large contact forces which can crush the strakes.

According to a first aspect of the present invention, there is a cladding section for mounting upon an elongate member to be deployed underwater, the cladding section being shaped to suppress vortex induced vibration of the elongate member when it is subject to a fluid flow, the cladding section comprising at least one cylindrical or part-cylindrical portion to seat upon the elongate member and at least one strake upstanding from the part-cylindrical portion, the cladding section being characterised in that the strake is resilient, enabling it to be deformed when subject to load and to reform following removal of the load.

According to a second aspect of the present invention, there is a method of manufacturing a cladding section for mounting upon an elongate member to be deployed underwater, the method comprising thermoforming sheet material to shape it to provide at least one part-cylindrical portion and at least one hollow strake upstanding from the part-cylindrical portion, wherein sheet material forming the strake is resilient so that in use the strake is able to be deformed when subject to load and to reform following removal of the load.

In alternative aspects, the strake is not hollow but is filled with a resilient material or is a solid resilient material The strake may be filled with or comprise a moulded material. The strake may be filled with or comprise a polyurethane material, or other suitable soft and/or resilient material.

Whilst the material may be thermoformed, it is also possible to prepare suitable cladding sections in accordance with the present invention by compression moulding or injection moulding. Disclosures herein in relation to thermoforming should also where appropriate be understood as applicable to moulding, mutatis mutandis. One advantage of moulding rather than thermoforming is that it expands the range of materials which can be used; one example of a suitable material is rubber crumb which is very resilient and cost-effective.

According to a further aspect of the present invention, there is a cladding section for mounting upon an elongate member to be deployed underwater, the cladding section being shaped to suppress vortex induced vibration of the elongate member which it is subject to a fluid flow, the cladding section comprising at least two part-cylindrical portions each carrying a respective upstanding strake, the two part-cylindrical portions being formed as a unitary plastics component having a hinge line between the two part-cylindrical portions which is relatively pliant so that the component bends preferentially about the hinge lane, enabling the cladding section to be reconfigured from a quasi-flat state to a state in which it forms a tube for receiving the elongate member, the cladding section being characterised in that material at the hinge line is (a) cut away along part of the hinge line to leave one or more binge portions and/or (b) thinned along the hinge line to facilitate bending along that line.

Specific embodiments of the present invention will now be described, by way of example only, with reference to the accompanying drawings, in which:

FIG. 1 is taken from the above mentioned prior art document PCT/GB2004/003709 and shows, in perspective, a single thermoformed cladding section belonging to the prior art and configured for use:

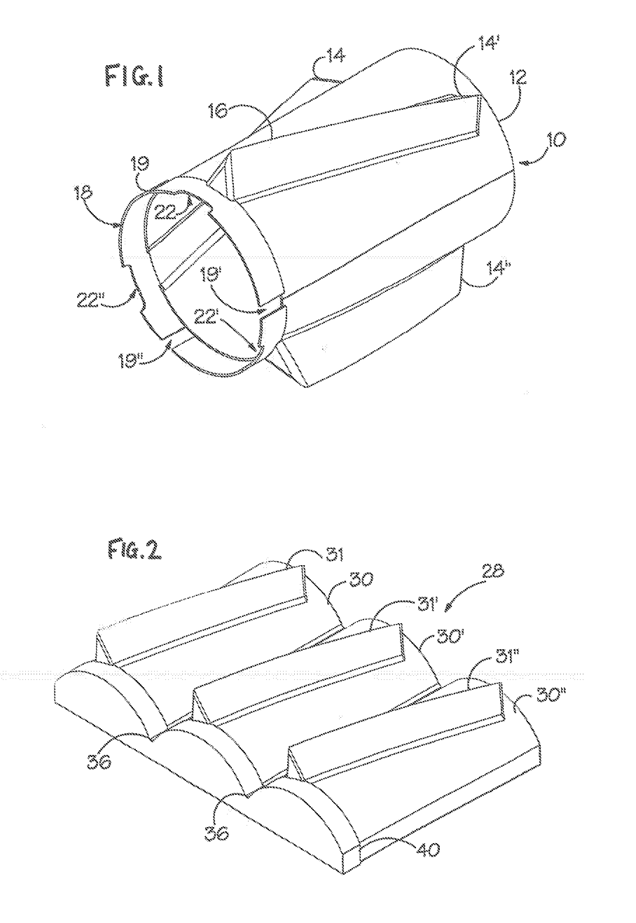

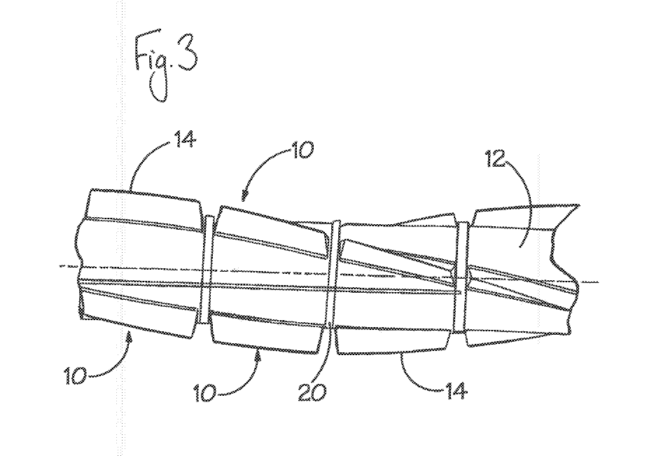

FIG. 2 is also taken from PCT/GB2004/003709 and shows a form tool for use in thermoforming the prior art cladding section of FIG. 1;

FIG. 3 is also taken from PCT/GB2004/003709 and shows multiple prior art cladding sections mounted on a marine riser;

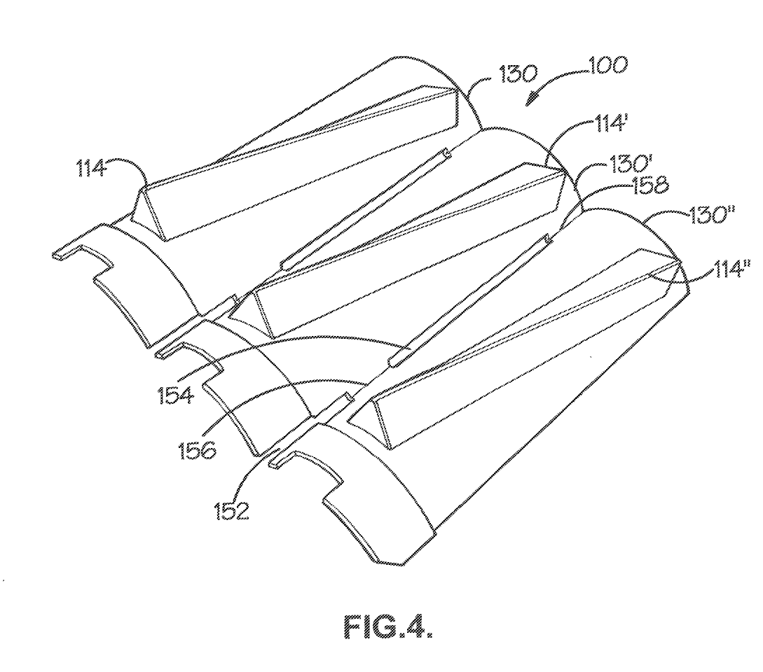

FIG. 4 is a perspective representation of a first cladding section embodying the present invention, viewed from above;

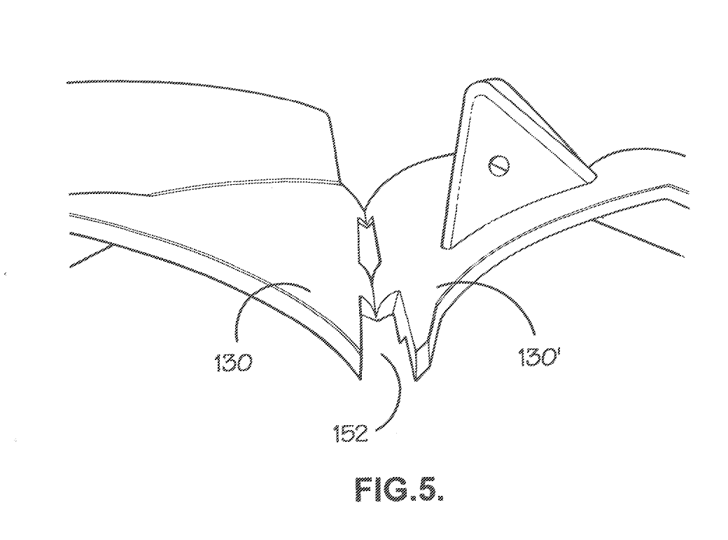

FIG. 5 shows part of the FIG. 4 cladding section, in perspective and viewed from one end; and

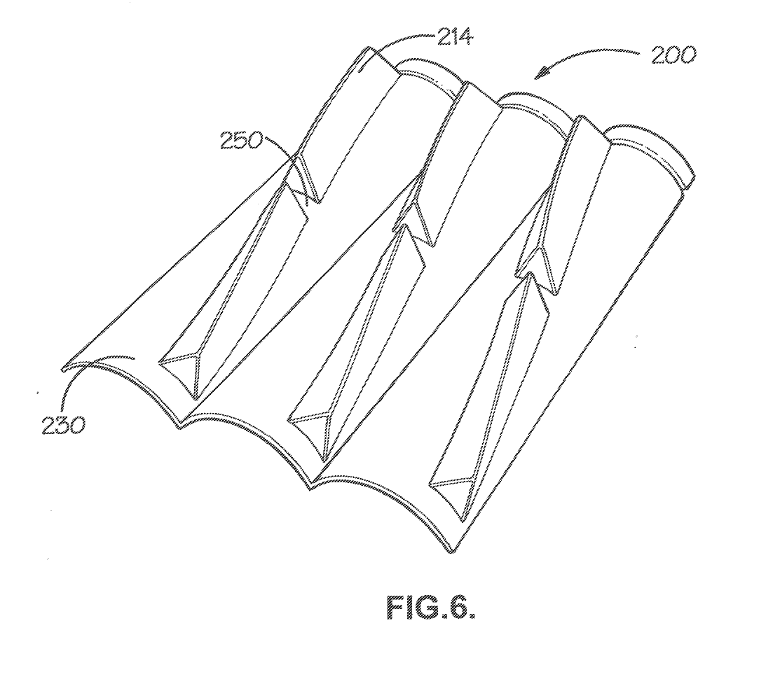

FIG. 6 shows another cladding section embodying the present invention, in perspective and viewed from above and to one side.

The prior art cladding section 10 of FIGS. 1 to 3 is manufactured from polyethylene sheet by a thermoforming technique and more specifically by vacuum forming. When installed upon an elongate underwater member (not shown) such as a marine riser, the cladding section 10 forms a tubular sheath 12 extending all the way around the circumference of the member and having longitudinally extending, upstanding strakes 14, 14′.

In use (FIG. 3) numerous cladding sections 10 are placed end-to-end in a string and their strakes 14, being inclined to the axis of the sheath 12, together form shallow pitched helices along the length of the underwater member. In the present embodiment three strakes are used and are regularly circumferentially spaced, so that the helical lines of strakes are configured in the manner of a triple start screw thread. The result is that the cladding is omnidirectional, in the sense that it serves to suppress vortex induced vibration equally effectively for any direction of flow.

The strakes each have an exposed vertex 16 which tends to “trip” flow over the cladding—i.e. to promote the transition from laminar to turbulent flow. The resulting controlled transition from laminar to turbulent flow typically does not give rise to vortex induced vibration. The illustrated strakes are of triangular cross section and are hollow, as a result of the thermoforming process. Other strake profiles and shapes can serve the purpose of controlling vortex induced vibration and could be adopted in embodiments of the present invention.

The cladding section 10 is shaped to mate with neighbouring, similarly formed sections in a string. In the illustrated example this mating is achieved by virtue of a “joggle” an enlarged diameter portion 18 of the tubular sheath 12 which is internally sized to receive the opposite (non-enlarged) end of the neighbouring cladding section. A tension band 20 (FIG. 3) is then placed around the enlarged diameter portion 18 serving to secure the sections in place around the elongate member and to secure the two cladding sections together. The enlarged diameter portion 18 is cut away at 19, 19′, 19″ to allow it to be deformed radially inwardly under pressure from the tension band.

The cladding section is also provided with indexing features serving to control the relative angular positions of neighbouring sections and hence to ensure that their strakes align to form a continuous helical line. In the illustrated embodiment these take the form of cut-aways 22, 22′, 22″ which receive ends of the helical strakes of the neighbouring section and so define the relative annular positions of the sections.

The cylindrical shape seen in FIG. 1 is not well suited to thermoforming. Instead the form tool or mould 28 seen in FIG. 2 is used, having three co-planar part-cylindrical portions 30, 30′, 30″ which are each parallel and separated from their neighbour by a short distance at 36. Each part-cylindrical portion carries a projection 31, 31′, 31″ to form a respective strake. This formation of the mould allows for easy release of the thermoformed cladding section. The overall length of the section is limited in relation to the pitch of the helix of the strakes, since too large an angular difference between one end of the strake and the other would result in the mould being undercut, creating difficulties in the thermoforming process and/or in release from the mould. Note that one end of the mould 28 is stepped at 40 to form the enlarged diameter portion 18.

Upon removal from the mould, the upper surface of the cladding section 10 has of course very much the same shape as the upper surface of the mould 28. Because of the presence of the inclined strakes 14, 14′, each of the part-cylindrical portions of the section tends to retain its shape. However strips of material joining these portions (corresponding to the regions 36 of the mould) act as flexible hinges allowing the three part cylindrical sections to be rotated relative to each other and so arranged to form together a complete cylinder as seen in FIG. 1.

The actual process of vacuum forming is very well known. The product is formed from plastics sheet which is rendered formable by heating and then drawn against the mould surface by creation of a partial vacuum between the mould and the plastics sheet. Vacuum holes are required in the mould 28. These are not shown in FIG. 2 but their formation is conventional. This prior art cladding section was to be formed, of polyethylene sheet.

The cladding sections are initially configured in a “quasi-flat” state corresponding to the shape of the form tool seen in FIG. 2. In this state they can be stacked one upon another, making a very compact arrangement for storage and transport.

While FIGS. 1 to 3 represent the prior art, FIGS. 4 and 5 illustrate a cladding section 100 embodying the present invention, in many respects the cladding section 100 is similar to the cladding section 10 of FIG. 1. Features common to both versions will not be described again, other than to note that the cladding section 100 is like the prior art section, a thermoformed item with part-cylindrical portions 130, 130′, 130″ each carrying a respective ant-VIV snake 114, 114′, 114″, with the part-cylindrical portions being joined by integral hinges enabling the cladding section to be transformed from the “quasi-flat” state of FIGS. 4 and 5 to a cylindrical configuration (not shown, but equivalent to that of FIG. 1),

The cladding section 100 differs from the prior art cladding section described above with respect to the formation of its hinges.

If the sheet material of the cladding section 110 is relatively thick and/or stiff the section can become difficult to manage during installation and its cylindrical shape can be undesirably distorted following installation. The problem is overcome by:
(a) cutting away material selectively in the region between neighbouring part-cylindrical portions 130 to leave a set of individual hinges in this region and/or
(b) thinning the material selectively in this region to facilitate its bending.

The first of these features is best illustrated in FIG. 4 in which regions 152, 154 of the cladding section's sheet material extending along the hinge line between neighbouring part-cylindrical portions 130 are seen to have been removed, leaving a pair of hinges 156. 158. In the illustrated example these axe adjacent the section's two ends, helping to ensure that these parts are aligned during installation of the cladding. In other embodiments the number and/or arrangement of the hinges may be varied. Three, four or more hinges may be favoured, or a single hinge with cut-aways on either side. The cut-away regions 152, 154 can be formed by machining after the thermoforming process.

The thinning of the section's sheet material at die hinge is best illustrated in FIG. 5, where it can be seen that upper and lower surfaces of the material (forming the hinge 152) have a shallow “V” section so that the material is thinnest at the mid line of the hinge and tends to bend in this region. Trials have shown this section to be particularly effective but there are other possible profiles which may be adopted, including “U” and “W” profiles. The profile can be formed by means of a plug applied to the sheet material during the thermoforming process (a procedure known to those skilled in the art as “plug assist”). Trials have shown that while flat bottomed “U” and “W” shaped hinge profiles can be used, the resultant hinge properties are not optimal When the cladding section is mounted, the tips of the “U” profile contact the elongate member and two binges are formed on either side of the hinge line. A “V” shaped profile avoids this effect.

FIG. 6 illustrates a further embodiment. Note that although FIG. 6 lacks any detail of the hinges, they may be cut away and/or profiled similarly to the binges described with reference to FIGS. 4 and 5. In many other respects the cladding section 200 of FIG. 6 is similar to the cladding section 10 already described. However the cladding section 200 differs from earlier described versions in that its helical strakes 214 each incorporate a break 250 mid-way along their length. The breaks 250 of all the strakes align laterally (or, when the cladding section 200 is in its cylindrical configuration one can say that they lie on a common circumference) so that they can accommodate an extra tension band (not shown). This is desirable with relatively long cladding sections which could otherwise bulge and/or open along their split line mid-way along their length. At the breaks 250, the strakes 214 are absent and the material of the cladding section 200 lies in the part-cylindrical plane of the part-cylindrical portion 230.

In FIG. 6 there is a single set of breaks 250 to accommodate one extra band, placed halfway along the cladding section's length. In principle the extra band could be offset from the midpoint and/or more bands could be provided using multiple sets of breaks.

In some embodiments (not illustrated) some form of spring may be incorporated in order to retain tension in the bands used to secure the cladding section 100, 200 in place. In some applications the diameter of the elongate member on which the cladding section is mounted may change over time, e.g. due to fluctuations in pressure in a tubular member, or fluctuations in temperature, or due to material creep. There is also the possibility of creep or settling of the parts making up the cladding section and/or the tension band. To ensure that such factors do not cause loss of band tension and consequent failures, some compliance can be provided. One way to do this is to incorporate an elastomeric layer or part within the tension band, to be pre-stressed upon installation of the tension band. This preferably takes the form of an elastomer layer either on the outside of the cladding section 10, 100, 200 or on the inner face of the band.

As noted above, the prior art cladding of PCT/GB2004/003709 was to be formed of polyethylene sheet. In deploying elongate members having this known cladding, it was necessary to ensure that little or no load was applied to the strakes which might otherwise crush them. The known cladding was also potentially unsuitable where external loads would be applied in use. This could limit the cladding's range of applications, For example known methods of deploying risers used in hydrocarbon extraction can involve the riser being fed out through a roller box having “V”, “U” or other shaped rollers. Large loads are applied by the rollers which would crush the strokes 114, 214. In another scenario a pipe is laid on the sea bed, a technique referred to as “wet storage” in the oil industry, and its weight would crush the strakes.

The inventors have considered formation of the cladding section from material resilient enough to enable the strakes to completely deform on application of load and then reform after the load's removal. That is, having been, crushed flat the strakes would, “pop up”. However trials show cladding sections formed of adequately resilient material to be prone to problems during deployment through a roller box. As the elongate member moves through the roller box, a “wave” of material of the cladding section is formed ahead of the roller due to the flexibility of the material. When a tension band reaches the roller, the material can pinch over the band and be torn, or moved to form a fold which can resist reformation of the strake profile.

The inventors have devised several, solutions to these problems.

Suitable materials for use in cladding sections having resilient strakes include thermoplastic polyurethane (TPU) and, more generally, thermoplastic elastomer (TPE). One suitable TPE comprises EPDM (ethylene propylene diene monomer, or “M class”) rubber and polypropylene (PP). Proportions of these constituents can be chosen to provide desired material properties. An increase in EPDM content reduces stiffness. Typical ratios (EPDM:PP) include 70:30, 85:15, 90:10 and 95:5. By appropriate selection of material thickness and stiffness, the aforementioned “roller wave” problem can be avoided or at least reduced while providing strakes with sufficient resilience to reform after deformation. The materials in question can be thermoformed.

The cladding section may comprise multi-layered material. In such embodiments a relatively stiff layer may be incorporated to avoid the roller wave problem, along with a relatively soft and resilient layer to provide the required resilience of the strakes. For example the cladding section may be manufactured from a sheet having a layer of relatively soft, resilient material such as TPE and a layer of stiffer high density polyethylene. The stiffer layer would typically be thinner than the other. During thermoforming, material forming the strakes 114, 214 is stretched and elongated, to the extent that the stiffer layer loses stillness in these regions. Material forming the part-cylindrical potions 130, 230 is stretched much less and retains its stiffness, providing a relatively stiff cylindrical cladding—to resist the roller wave—and relatively resilient strakes 114, 214 capable of reforming after crushing. Suitable multi-layer materials may for example be formed (a) by co-extrusion or (b) by putting multiple sheets together, e.g. during the thermoforming process.

The roller wave problem may be addressed using material having directional properties. In particular, stiffening fibres may be incorporated in the cladding section 100, 200 to resist formation of the roller wave while permitting the strakes 114, 214 to deform and reform. Such fibres are, in the favoured embodiments, aligned generally along the length of the cladding section (i.e. they extend along the axial direction when the cladding section 100, 200 is configured as a cylinder). Aramid fibres are suitable although other materials may be used. They may be incorporated in the sheet during its manufacture or may be added later, e.g. during thermoforming.

Directional reinforcement can provide stiffness along the length of the cladding, to alleviate the roller wave problem, while permitting the deformation (largely in directions transverse to the reinforcement direction) needed for the strakes 114, 214 to deform and reform.

Reinforcement may be concentrated in the part-cylindrical portions 130, 230 and may be absent, or reduced, in the strakes 114, 214. This can be achieved by virtue of the thermoforming process. As the strakes 114, 214 are pushed out, the fibre reinforcement is pushed to either side of the strakes, leaving a lower concentration of fibres in the strakes themselves. Alternatively it can be achieved by arranging the reinforcement suitably prior to the moulding process. For example fibre reinforcement may be suitably arranged on the thermoforming took with little or no reinforcement in the regions of the strakes and/or the hinges.

The reinforcement fibres may be chosen to withstand the thermoforming temperature while retaining their properties. Alternatively they may be chosen to become soft or molten during thermoforming, enabling them to stretch in forming the strakes and/or the hinges.

In another embodiment, two separate shaped sheet layers are shaped and then brought together and bonded. A first, relatively resilient, layer may form both the strakes 114, 214 and the part-cylindrical portions 130, 230. A second, stiffer, layer may form the part-cylindrical potions but be cut away in the regions of the strakes 114, 214. In this way a cladding section 100, 200 is formed having relatively flexible, resilient strakes and a stiffer cylindrical body. A suitable manufacturing technique is thermoforming using a dual impression tool, in conventional vacuum forming a single sheet is blown and a single mould tool is brought into the blown cavity. A vacuum is created to draw the sheet onto the tool and so shape it. In dual impression thermoforming two mould tools are used, their shapes being complementary—features which are male in one tool are female in the other, so that the two tools can be brought together with the sheet material between them. One sheet is vacuum formed upon one tool. The other sheet is vacuum, formed on the other tool. The two tools are brought together, with the sheet material still in a semi-molten state, and fused or bonded to form a single component.

The aforegoing embodiments are presented as examples only of the manner in which the present invention can be implemented. Numerous variants and alternatives falling within the scope of the appended claims will be apparent to the skilled person. While the aforegoing embodiments are thermoformed items, alternative embodiments may instead utilize other moulding processes including injection moulding.

1. A cladding section for mounting upon an elongate member to be deployed underwater, the cladding section being shaped to suppress vortex induced vibration of the elongate member when it is subject to a fluid flow, the cladding section comprising at least one cylindrical or part-cylindrical portion to seat upon the elongate member and at least one stake upstanding from the part-cylindrical portion, the cladding section being characterised in that the stake is resilient, enabling it to be deformed when subject to load and to reform following removal of the load.

2. A cladding section as claimed in claim 1 which is a unitary thermoformed component.

3. A cladding section as claimed in claim 1 or claim 2 in which the strake is hollow.

4. A cladding section as claimed in any preceding claim in which the strake is filled with a resilient material.

5. A cladding section, as claimed in claim 4 in which the stake is filled with a moulded material.

6. A cladding section as claimed in claim 4 or claim 5 in which the strake is filled with a polyurethane material.

7. A cladding section as claimed in any preceding claim which comprises a plurality of part-cylindrical portions joined by hinges, enabling it to be reconfigured from a quasi-flat state in which the part-cylindrical portions lie side-by-side and a state in which it forms a tube for receiving the elongate member.

8. A cladding section as claimed in claim 7 which is shaped to allow multiple cladding sections to be closely stacked in the quasi-flat state.

9. A cladding section as claimed in any preceding claim which is provided with a mating feature for mating with an adjacent, identically formed, cladding section.

10. A cladding section as claimed in any preceding claim in which the strake is helical in shape and extends longitudinally of the cladding.

11. A cladding section as claimed in any preceding claim in which the part-cylindrical portion is stiller than the strake.

12. A cladding section as claimed in claim 11 in which the part-cylindrical portion and the strake are both formed of sheet material, the material of the part-cylindrical portion being thicker and/or stiffer than that of the strake.

13. A cladding section as claimed in any preceding claim whose structure comprises first and second layers, the first layer comprising material which is resilient and relatively pliant and the second layer comprising material which is relatively stiff.

14. A cladding section as claimed in claim 13 in which the first layer comprises a thermoplastic elastomer or a thermoplastic polyurethane.

15. A cladding section as claimed in claim 13 or claim 14 in which the second layer comprises polyethylene or polypropylene.

16. A cladding section as claimed in any of claims 13 to 15 in which the second layer is thinner in the regions forming the strake than in the regions forming the part-cylindrical portion.

17. A cladding section as claimed in any of claims 13 to 15 in which the second layer is absent from regions forming the strake and present in regions forming the part-cylindrical portion.

18. A cladding section as claimed in any preceding claim comprising sheet material whose tensile stiffness is greater along in a direction along the length of the part-cylindrical portion than in a direction about its circumference.

19. A cladding section as claimed in claim 18 incorporating fibre reinforcement which is wholly or at least preferentially aligned along the length of the part-cylindrical portion.

20. A cladding section as claimed in claim 19 in which density of the fibre reinforcement is greater in the part-cylindrical portion than in the strake.

21. A cladding section as claimed in claim 19 in which the fibre reinforcement is present in the part-cylindrical portion and absent from the strake.

22. A cladding section, as claimed in any preceding claim which is compression moulded, or injection moulded or comprises one or more compression moulded or injection moulded component.

23. A cladding section as claimed in claim 22 comprising rubber crumb material.

24. A method of manufacturing a cladding section for mounting upon an elongate member to be deployed underwater, the method comprising thermoforming sheet material to shape it to provide at least one part-cylindrical portion and at least one hollow strake upstanding from the pan-cylindrical portion, wherein sheet material forming the strake is resilient so that in use the strake is able to be deformed when subject to load and to reform following removal of the load.

25. A method as claimed in claim 24 further comprising the step of filling the hollow strake with a resilient material.

26. A method as claimed in claim 25 wherein the resilient material used to fill the hollow strake is a moulded material.

27. A method as claimed in claim 25 or claim 26 wherein the resilient material used to fill the hollow strake is a polyurethane material.

28. A method of manufacturing a cladding section for mounting upon an elongate member to be deployed underwater, the method comprising thermoforming sheet material to shape it to provide at least one part-cylindrical portion and at least one strake upstanding from the part-cylindrical portion, wherein the strake comprises resilient material so that in use the strake is able to be deformed when subject to load and to reform following removal of the load.

29. A method as claimed in claim 28 in which the resilient material is a moulded material.

30. A method as claimed in claim 28 or claim 29 wherein the resilient material is a polyurethane material.

31. A method as claimed in any of claims 24 to 30 comprising thermoforming at least first and second layers, the first layer comprising material which is resilient and relatively pliant and the second layer comprising material which is relatively stiff, the two layers being coupled to one another in the finished cladding section.

32. A method as claimed in claim 31 comprising thinning the second layer during thermoforming in the region of the strake by stretching the sheet material in that region.

33. A method as claimed in any of claims 24 to 31 wherein the second layer is cut away in a region forming the strake.

34. A method as claimed in any of claims 24 to 31 or 33 which comprises dual impression thermoforming, the first layer being shaped on a first form tool and the second layer being shaped on a second form tool shaped to complement the first, the two form tools being brought together to assemble the two layers to one another.

35. A method as claimed in any of claims 24 to 30 comprising incorporating fibre reinforcement, into the sheet material.

36. A method as claimed in claim 35 in which the fibre reinforcement is aligned, wholly or at least preferentially, along the length of the part-cylindrical portion.

37. A method as claimed in claim 35 or claim 36 in which the density of the fibre reinforcement in regions of the sheet material is reduced, during the thermoforming process, by virtue of the fibre reinforcement being pushed away from these regions by the action of a form tool.

38. A method as claimed in claim 35 or claim 36 in which fibre reinforcement is laid up on a form tool and is then applied to the sheet material, the fibre reinforcement being arranged so that it is absent, or so that its density is reduced. in a region of the form tool which forms the strake.

39. A method of manufacturing a cladding section for mounting upon an elongate member to be deployed underwater, the method comprising compression moulding or injection moulding material to shape it to provide at least one part-cylindrical portion and at least one hollow strake upstanding from the part-cylindrical portion, wherein material fanning the strake is resilient so that in use the strake is able to be deformed when subject to load and to reform following removal of the load.

40. A method as claimed in claim 39 wherein the material is rubber crumb.

41. A method as claimed in claim 39 or claim 40 further comprising the step of filling the hollow strake with a resilient material.

42. A method as claimed in claim 41 wherein the resilient material used to fill the hollow strake is a moulded material.

43. A method as claimed in claim 41 or claim 42 wherein the resilient material used to fill the hollow strake is a polyurethane material.

44. A method of manufacturing a cladding section for mounting upon an elongate member to be deployed underwater, the method comprising compression moulding or injection moulding material to shape it to provide at least one part-cylindrical portion and at least one strake upstanding from the part-cylindrical portion, wherein the strake comprises resilient material so that in use the strake is able to be deformed when subject to load and to reform following removal of the load.

45. A method as claimed in claim 44 wherein the material is rubber crumb.

46. A method as claimed in any of claims 39 to 45 comprising forming at least first and second layers, the first layer comprising material which is resilient and relatively pliant and the second layer comprising material which is relatively stiff, the two layers being coupled to one another in the finished cladding section.

47. A method as claimed in claim 46 comprising thinning the second layer during forming in the region of the strake by stretching the sheet material in that

48. A method as claimed in any of claims 39 to 46 wherein the second layer is cut away in a region forming the strake.

49. A method as claimed in any of claims 39 to 46 or 48 which comprises dual impression forming, the first layer being shaped on a first form tool and the second layer being shaped on a second form tool shaped to complement the first, the two form tools being brought together to assemble the two layers to one another.

50. A method as claimed in any of claims 39 to 45 comprising incorporating fibre reinforcement, into the material.

51. A method as claimed in claim 50 in which the fibre reinforcement is aligned, wholly or at least preferentially, along the length of the part-cylindrical portion.

52. A method as claimed in claim 50 or claim 51 in which the density of the fibre reinforcement in regions of the sheet material is reduced, during the thermoforming process, by virtue of the fibre reinforcement being pushed away from these regions by the action of a form tool.

53. A cladding section for mounting upon an elongate member to be deployed underwater, the cladding section being shaped to suppress vortex induced vibration of the elongate member which it is subject to a fluid flow, the cladding section comprising at least two part-cylindrical portions each carrying a respective upstanding strake, the two part-cylindrical portions being formed as a unitary plastics component having a hinge line between the two part-cylindrical portions which is relatively pliant so that the component bends preferentially about the hinge lane, enabling the cladding section, to be reconfigured from a quasi-flat state to a state in which it forms a tube for receiving the elongate member, the cladding section being characterised in that material at the hinge line is (a) cut away along part of the hinge line to leave one or more hinge portions and/or (b) thinned along the hinge line to facilitate bending along that line.

54. A cladding section as claimed in claim 53 in which upper and/or lower faces of the component have a “V” profile.

55. A cladding section as claimed in claim 53 or claim 54 in which material at the hinge line is cut away to define at least two discrete hinges.
